(19) United States
(12) Patent Application Publication
(10) Pub. No.: US 2012/0224948 A1
(43) Pub. Date: Sep. 6, 2012

(54) Rail system and method for securing a heavy load to a flat bed truck

(76) Inventor: Timothy Pajak, Burbank, IL (US)

(21) Appl. No.: 13/068,675

(22) Filed: May 16, 2011

Related U.S. Application Data
(60) Provisional application No. 61/345,019, filed on May 14, 2010.

(51) Int. Cl. B65G 67/00; B60P 7/06

(52) U.S. Cl. 414/809; 410/121; 410/47

(57) ABSTRACT

The invention provides a detachable railing system for assisting in securing a load to a flat bed truck. The railing systems of the invention include a plurality of detachable stakes have one end dimensioned for telescopic mating with a pocket formed along the periphery of the flat bed truck. Each of the plurality of stakes has a saddle portion extending outwardly therefrom and which is dimensioned for receipt of one end of an arm. A plurality of arms is dimensioned to be inserted into at least one of the saddles of the plurality of stakes and is further dimensioned to span the length between adjacent stakes when the stakes are mounted a predetermined distance apart near the periphery of the flat bed truck. The plurality of arms is further adapted to detachably mounted into at least one of the saddle portions of at least one of the plurality of stakes.

### FIELD OF INVENTION

This invention relates generally to system and method for securing a load to a flat bed truck. More particularly, the system and method include a removable railing system for ensuring that a load remains on a flat bed truck during transit, but which can be removed when necessary to assist in unloading of the truck.

### BACKGROUND OF THE INVENTION

A quite common type of truck trailer is the so-called “stake bed truck” that provides a flat cargo area with no roof or permanently affixed sidewalls. These types of vehicles are typically used to carry very heavy loads, generally of the character that the load needs to be placed on the truck with the use of a crane or fork lift truck. The stakes are typically removable from a series of spaced apart pockets provided around the periphery of the truck bed in a rub rail that borders the bed. Straps or chains are typically secured to the stakes or to the rub rail adjacent to the pockets and placed over the load to secure it to the truck bed. For the transportation of rolled steel products, the pockets are often spaced apart at intervals of about 21 inches along the periphery of the truck.

Presently, compact, heavy objects that have rounded surfaces can be difficult to transport on such conventional flat bed trucks. For example, the transport of cylindrical coils of rolled sheet steel has proven particularly problematic to transfer safely and efficiently with a flat bed truck. Such rolls of sheet steel typically vary in their dimensions from a diameter of 24 inches to 36 inches and a width from 12 inches to 36 inches. Rolls of sheet steel are difficult to transport because even relatively narrow rolls (less than 21 inches) often weigh more than 700 pounds. Even when strapped down to the conventional steel stake systems typically utilized with flat bed trucks, steel rolls can, due to their weight, compact size and curved outer surface, work free of the strapping and roll off of the bed of the truck. Such an occurrence can create a very dangerous situation for the truck driver and the other vehicles traveling the roads. Also, since the heavy loads that flat bed trucks carry usually necessitate being loaded from their sides by one or more forklifts, it is important that any system for securing such loads allow for easy access to the sides of the truck. Thus, there is a need for a more secure way to transport heavy dense, but highly mobile cargo, such as rolls of sheet steel, on flat bed trucks, which also allows for efficient access to the sides of the truck in order to unload the cargo with a forklift.

One prior attempt to provide flat bed trucks and trailers with a load securing structure was to equip them with longitudinally spaced-apart, insertable gates, which can be removed during loading and then reinstalled after loading to secure the load in place on the bed of the truck. Typically, the prior art gates were constructed from at least two elongated vertically extending stakes that are telescopically receivable within longitudinally spaced-apart pockets provided along the sides of the truck bed. The vertical stakes were sometimes connected together by vertically spaced-apart wooden or metal slats that are typically about 4 to 6 feet long. U.S. Pat. No. 6,325,438 B1 discloses a side gate assembly that is hinged to the flat bed in a manner that allows them to be folded onto the truck to allow the loaded from the side by a forklift truck. However, the system of the '438 patent is bulky, complex and costly and thus inadequate for many situations. Furthermore, the light weight construction of the hinged, foldable gates and the wide spacing of their stake members do not provide a sufficiently robust structure to prevent a seven hundred pound roll of sheet steel from breaking through the gates and falling off of the flat bed.

For the transportation of logs, special flat beds logging trucks or trailers have been designed with movable stakes that constrain the logs on the truck or trailer. These stakes are placed inside a bunk pocket. The bunk pockets are secured to a bunk which is a member that passes under the truck or trailer bed and supports the bunk pocket into which the stakes are placed. Once the logs are placed on the trailer inside the stakes, a safety wrapper chain or strap is added to further secure the logs to the truck or trailer bed in compliance with transportation regulations. U.S. Pat. No. 6,722,828 B2 discloses a logging truck with a system configured to constraining logs to be hauled on a truck or trailer without the use of safety wrapper chains or straps to secure the load. This is accomplished by utilizing stakes, bunks, bunk pockets, a head board and a tail board to constrain logs on the bed of the truck or trailer. The stakes disclosed in the '828 patent constrain the logs movement from side to side on the truck or trailer. However, the stakes of the '828 patent are permanently mounted, which make it difficult to allow side fork lift access to the truck. Moreover, the spacing of the stakes in the '828 system would not be appropriate for loads that are more compact than logs, such as sheet steel rolls.

There are also a number of removable cover systems for flatbed trailers, which include stake-supported panels extending longitudinally along sides of the trailer and bow-supported tarp cover secured over the trailer and the upper portions of the panels. These systems are typically referred to as tarp-and-rack systems or side kits, and versions of these systems have been commercially available for a number of years. U.S. Pat. No. 7,350,842 B2 includes a relatively detailed discussion of various iterations of such systems. However, those systems involve more expense and labor to construct than is desirable and further are believed to lack the strength required to secure the relatively heavy, highly movable loads for which the current system has been designed. Further, where unloading or loading cargo requires ready forklift access to the sides of the truck, tarp and racks systems are too time-consuming and labor intensive to disassemble to be feasible for most jobs. Further, as such systems are primarily designed to sheltering cargo on the truck bed rather than securing heavy loads. Thus, they are not believed to be sufficiently robust for use with heavy, compact highly mobile cargo, like rolls of sheet steel.

### OBJECTS OF THE INVENTION

One object of the invention is to provide a cost effective system and method to assist in constraining heavy, dense highly mobile cargo, from falling off a flat bed truck during transit.

Another object of the invention is to provide such a robust rail system and method which further allows for quick and efficient forklift access from the sides of the flat bed truck for loading and unloading cargo therefrom.

A further objective is to provide a removable, adjustable rail system to assist in constraining a heavy, highly mobile load on a flat bed truck.

A still further object of the invention is to provide a method for providing side loading access to a flat bed truck through a rail system for assisting in securing a load to a flat bed truck.

### BRIEF SUMMARY OF THE INVENTION

One embodiment of the invention provides a detachable railing system for assisting in securing a load to a flat bed truck. The railing system including a plurality of detachable stakes have one end dimensioned for telescopic mating with a pocket formed along the periphery of the flat bed truck. Each of the plurality of stakes has a saddle portion extending outwardly therefrom and which is dimensioned for receipt of one end of an arm. A plurality of arms is dimensioned to be inserted into at least one of the saddles of the plurality of stakes and is further dimensioned to span the length between adjacent stakes when the stakes are mounted a predetermined distance apart near the periphery of the flat bed truck. The plurality of arms is further adapted to detachably mounted into at least one of the saddle portions of at least one of the plurality of stakes. Preferably, the arms are pivotally mounted to the saddles by means of a hinging bolt on a first end and a lock pin on a second end. In order for the pivotally mounted arm to clear the saddle portion during pivoting, its ends are preferably cut on angle to allow for rotation of the portion of the arm opposite the pivot bolt to swing past the saddle. Further, the plurality of stakes are each preferably provided with a stop block along at least one of their outer surfaces to ensure that they are at a uniform height when inserted into the plurality of pockets formed on the flat bed truck. Moreover, the stakes are also preferably provided with an arm retaining tang which is dimensioned for a tight friction fit with the arm when the arm is pivoted into a substantially upright position. Also, the tang is provided with a removable pin for temporarily securing the arm in an upright position during loading and unloading cargo.

In another embodiment of the invention, an alternate detachable railing system for assisting in securing a load to a flat bed truck is provided. The alternate railing system includes a plurality of detachable stakes have one end dimensioned for telescopic mating with a pocket formed along the periphery of the flat bed truck bed. Each of the plurality of stakes has a boot portion adjustably attached thereto. Each of the boots portions has at least one saddle portion extending outwardly therefrom, which is dimensioned for receipt of one end of an arm. Each of the boots, in turn, are dimensioned to telescopically mate with a stake such that the boots can slide along the vertical length of the stakes to allow the railing system of this embodiment of the invention to be adjusted to a plurality of different rail heights. A plurality of arms are dimensioned to be received into at least one of the saddles of the plurality of stakes, and the arms are further dimensioned to span the length between adjacent stakes when mounted a predetermined distance apart near the periphery of the flat bed truck. In one embodiment of the invention, including the adjustable boots, the arm portion may also be pivotally mounted to the saddles of the boot.

In a still further embodiment of the invention, a method and system is provided for converting conventional flat bed stakes into a railing system. The method includes providing a plurality of boots being adapted to be attached to conventional flat bed stakes. The plurality of boots are attached to each of the plurality of conventional stakes by attaching bolts or the like through the boot into holes drilled into the conventional stakes. Each of the boots portions has at least one saddle portion extending outwardly from each of the conventional stakes. The conversion kit further includes a plurality of arms that are dimensioned to be received into at least one of the saddles attached to each of the plurality of stakes and is further dimensioned to span the length between adjacent stakes when mounted a predetermined distance apart near the periphery of the flat bed truck. A first end of each of the plurality of arms is inserted into a saddle portion mounted to a first of the plurality of stakes. Then, a second end of each of the plurality of arms is inserted into an adjacent saddle attached to an adjacent conventional stake. In some cases, the conventional stakes may have holes already drilled in them at an acceptable height for mounting the boots. However, if this is not the case, the kit may include instructions for drilling appropriate holes for receipt of bolts for attaching the boots to the conventional stakes.

Still further, the present invention includes a method of loading or unloading a load from a flat bed truck including the steps of removing a mounting pin from a pivotally mounted arm forming at least a portion of a railing around the periphery of a flat bed truck. Next, the arm is pivoted upwardly into a substantially upright position to allow a forklift to access a load located on the flatbed truck between adjacent stakes of the railing system mounted along the periphery of the flat bed truck. If the load or the distance between the forks of the forklift to be removed is larger than the spacing between the stakes of the railing system, one or more of the stakes may be removed by first removing the locking pin on one end of the arm, pivoting the arm into its upright position, and pulling the stake from the pocket on the flat bed truck. In one preferred method the invention, the stakes are provided with a friction fit tang member that temporarily retains the vertical, pivoted arm while the load is being accessed by the forklift. In one preferred method of the invention, the pivoted arm is temporarily secured in the vertical position by the insertion of a pin through the arm and into a hole in the tang.

### BRIEF DESCRIPTION OF THE DRAWINGS

FIG. 1 is a plan view of a pair of stakes and an arm connecting same in accordance with one embodiment of the railing system of the invention;

FIG. 2 is a plan view of a pair of stakes with the arm raised and pinned into a tang in accordance with the railing system depicted in FIG. 1;

FIG. 3 is a plan view of a pair of stakes with the arm partially lowered in accordance with the railing system shown in FIG. 1;

FIG. 4 is an enlarged perspective view of a stake with arm attached thereto in a raised position with the arm secured in the tang by a pin in accordance with the railing system shown in FIG. 1;

FIG. 5 is an enlarged plan view of a partially disassembled stake with an arm detached there from in accordance with the railing system shown in FIG. 1;

FIG. 6 is a rub-rail on a flat bed truck for receipt of the stakes of railing system of the applicant's invention;

FIG. 7 is an enlarged perspective view of an alternate embodiment of a stake in accordance with an alternate embodiment of the railing system of the invention.

FIG. 8 is a plan view of a boot portion of the rail system of FIG. 7.

FIG. 9 is a side view of a boot portion of the rail system of FIG. 7.

FIG. 10 is a side view of an arm portion of the rail system of FIG. 7.

FIG. 11 is a perspective view of another alternate embodiment of the railing system of the invention showing the system assembled in a double arm configuration.

FIG. 12 is a perspective view of the railing system of FIG. 11 showing the arms in a partially upwardly pivoted position.

FIG. 13 is a perspective view of disassembled components of the railing system of FIG. 11.

### DETAILED DESCRIPTION OF THE PREFERRED EMBODIMENTS

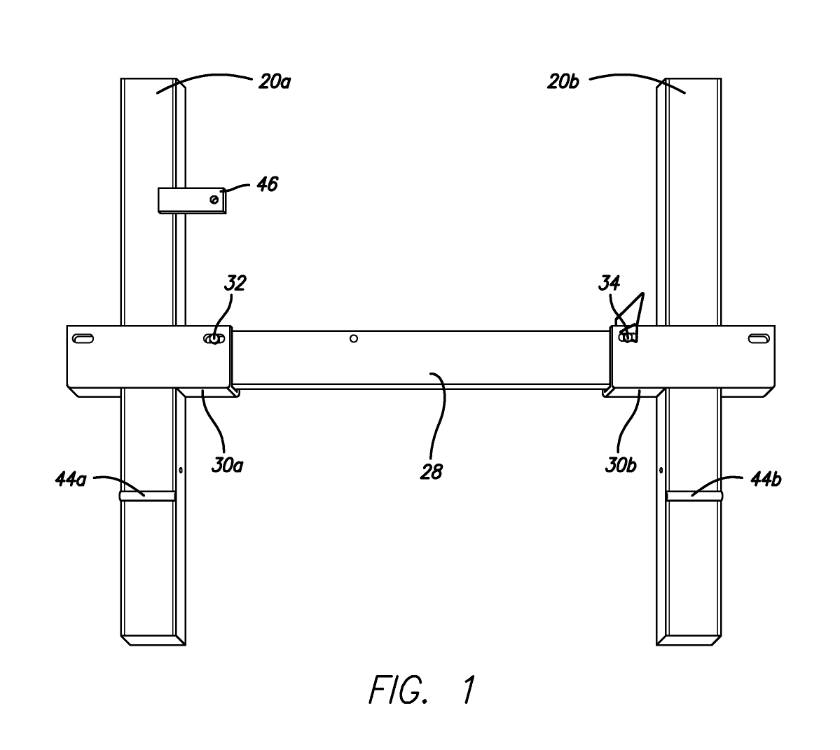

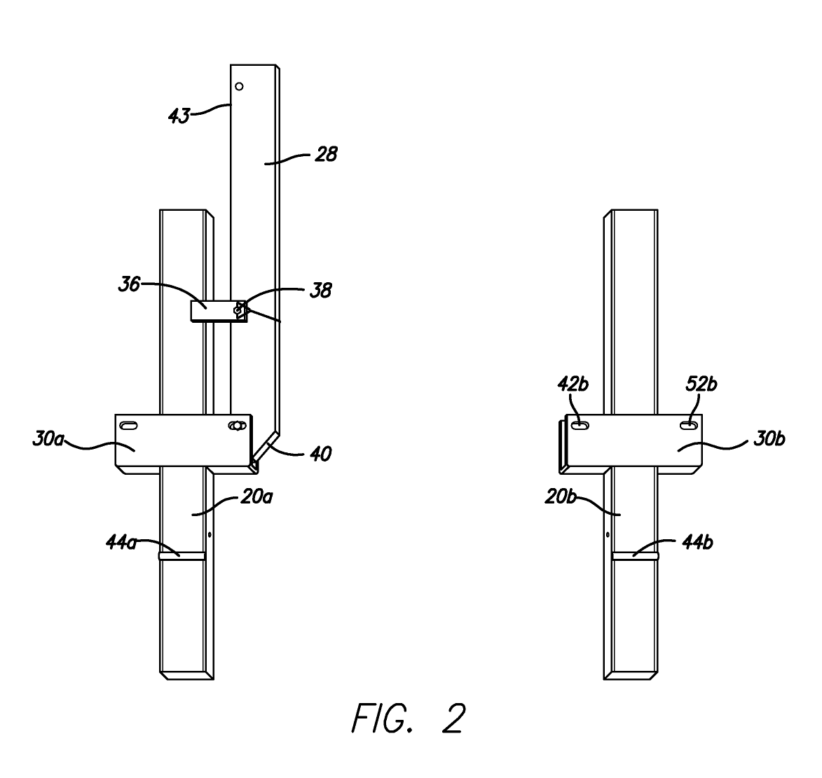

As shown in FIG. 2, one embodiment of the railing system of the invention includes at a plurality of stakes 20, which are dimensioned to be received into pockets 22 located in the rub-rail 24 of a flat bed truck 26. Each pair of stakes, e.g., 20a and 20b, include a connecting arm 28 which is dimensioned to span the distance between each pair of stakes. The connecting arm 28 is further dimensioned for receipt in saddles 30a, 30b on each of the stakes 20a, 20b. The arm 28 and stakes 20a, 20b combining to form one segment of the railing system in accordance with the embodiment of FIG. 1. The railing system of this embodiment of applicant's invention may include multiple railing segments arranged adjacent to one another, or alternately may have one or more gaps formed there between where the cargo being hauled lends its self to being securely retained by an intermittent rail arrangement. Railing systems in accordance with the embodiment of FIG. 1 have been field tested to withstand the force of a rolling 500/600 lbs. 2 inch thick solid wall steel being dropped from a height of about two feet causing a rolling velocity of about 5 mph onto a flat bed truck contacting the railing without damaging either the railing system of coiled steel roll.

Turning now in more detail to the stakes 20a, 20b, as shown in FIG. 1, when the arm 28 is fully assembled, it is held in place by bolt 32 on one end and a pin 34 on a second end. The pin 34 is preferably a temporary locking style pin, such as cotter type pin, so that the arm 28 can be securely affixed to the stake, but also easily removed therefrom in order to partially disassemble the railing system in order to allow side access to the flat by a forklift between the adjacent stakes. In this vein, FIG. 2 shows stakes 20a, 20b with arm 28 pivoted upwardly such that the arm 28 is held in that upright position by tang 36 and tang pin 38. Tang 36 is dimensioned for a friction fit with arm 28 when arm 28 is pivoted into its upright or partially disassembled configuration for purposes of unloading the cargo from the side with a fork lift. Tang pin 38 is also preferably a cotter style pin which allows the tang pin to be quickly and securely installed as well as removed to facilitate assembly and disassembly of the railing system. As can be further seen in FIG. 2, arm 28 includes a bias cut end 40 to prevent the end of the arm 28 from impinging on saddle 30a when being swung to its upright position. Stake 20b is provided with pin aperture 42, which is dimensioned to receive pin 34 during assembly of the rail system. Stakes 20a and 20b further include stops 44a, 44b, which are dimensioned to prevent over insertion of the stakes 20a and 20b into the pockets 22a, 22b of rub-rail 24. This keep the railing system at a uniform pre-determined height relative the bed. Where one or more cargo items are wider than the gap between the stakes, it will sometimes be necessary to remove one or more stake to access such wide cargo items with the fork lift from the side of the truck.

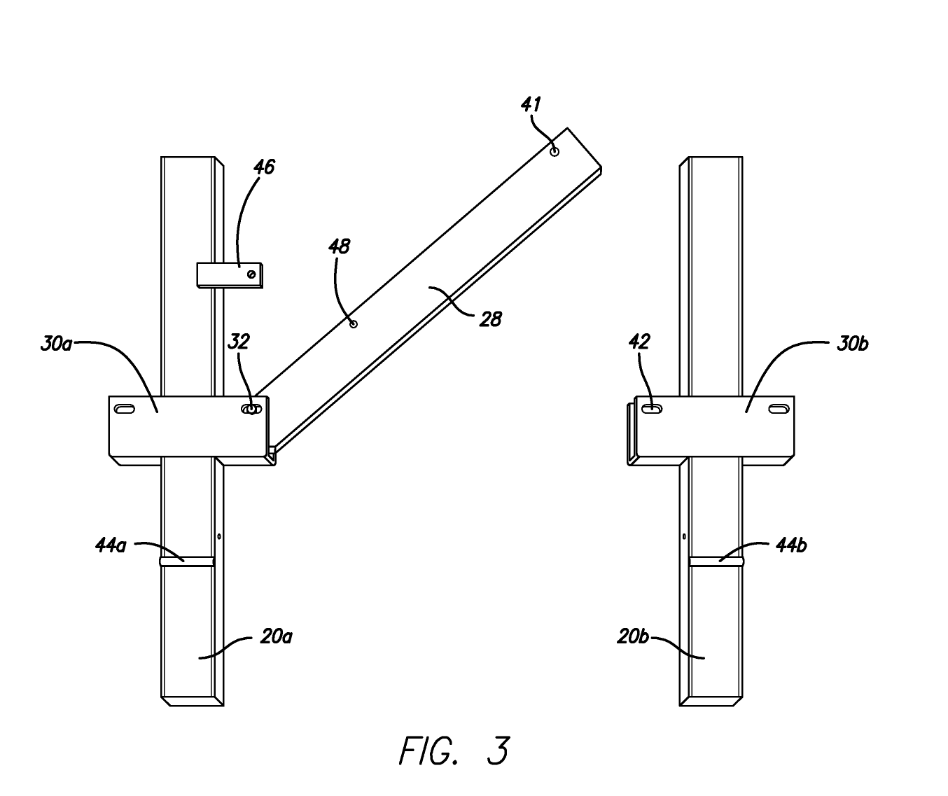

In FIG. 3, stakes 20a and 20b are shown with arm 28 partially pivoted toward sleeve 30b. Tang pin aperture 46 can be best seen in FIG. 3, and it is dimensioned for receipt of tang pin 38. Arm 28 further includes arm tang aperture 48, which is positioned and dimensioned to align with tang pin aperture 46 on stake 20a when arm 28 is fully pivoted into its upright position. Arm 28 is further provided with arm sleeve aperture 43 which is positioned and dimensioned to align with sleeve aperture 42 when arm 28 is fully downwardly pivoted into sleeve 30b.

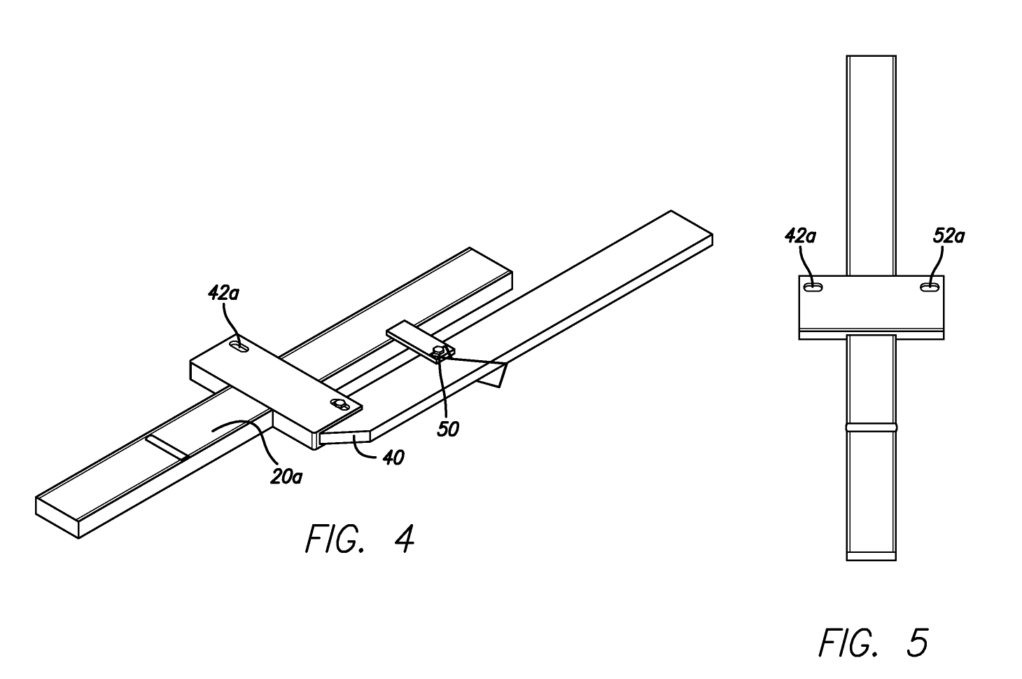

With regard to FIG. 4, arm 28 is shown in its fully upright position with a pin 38 securing it in that position. Pin 38 is shown with cotter element 50 inserted into pin and aperture formed on the end of pin 38 to prevent inadvertent swinging of arm 28 should, for example, a forklift or cargo bump into the arm during unloading of the flat bed 26 of the truck. Stake 20a may optionally include sleeve aperture 42a so that sleeve 30a may receive the second end of an additional arm piece (not shown) so that stakes may be joined sleeve to arm to sleeve to arm to create multiple segments to the rail system of the embodiment of FIGS. 1-5.

Concerning FIG. 5, stake 20a is shown without arm 28 connected thereto. In this view, arm aperture 52a is best seen. Arm pin aperture 52a is dimensioned for receipt of arm bolt 32. Arm bolt 32 may be secured with nut (not shown) to allow disassembly of arm and stake 20a. Optionally, bolt aperture 52a can be threaded on side of the sleeve so that bolt 32 can be tightened directly on the sleeve. Further, sleeve 30b may also be provided with a bolt aperture 52b dimensioned to receive a bolt (not shown) to secure a second arm to sleeve 30b in order to create a multiple segment railing system. The stakes 20a, 20b of the embodiment of FIGS. 1-5 are preferably manufactured from ⅛ thick, hollow tubing steel stock of ASTM A-500 Grade B. The sleeves 30a and 30b are preferably fabricated from 11 gauge steel tubing, steel stock and then welded to sleeves 20a and 20b, respectively. Tang 46 is welded to stake 20a. Stops 44a and 44b are fabricated from ½ inch A-36 HR Steel roll, steel stock and are then welded to stakes 20a and 20b. Each of the apertures 42a, 42b, 46, 48, 52a, 52b, are machined into the applicable part utilizing a CNC drilling tool. The arms 28 may also be made from ⅛ inch thick 6061-T6 grade aluminum tube stock.

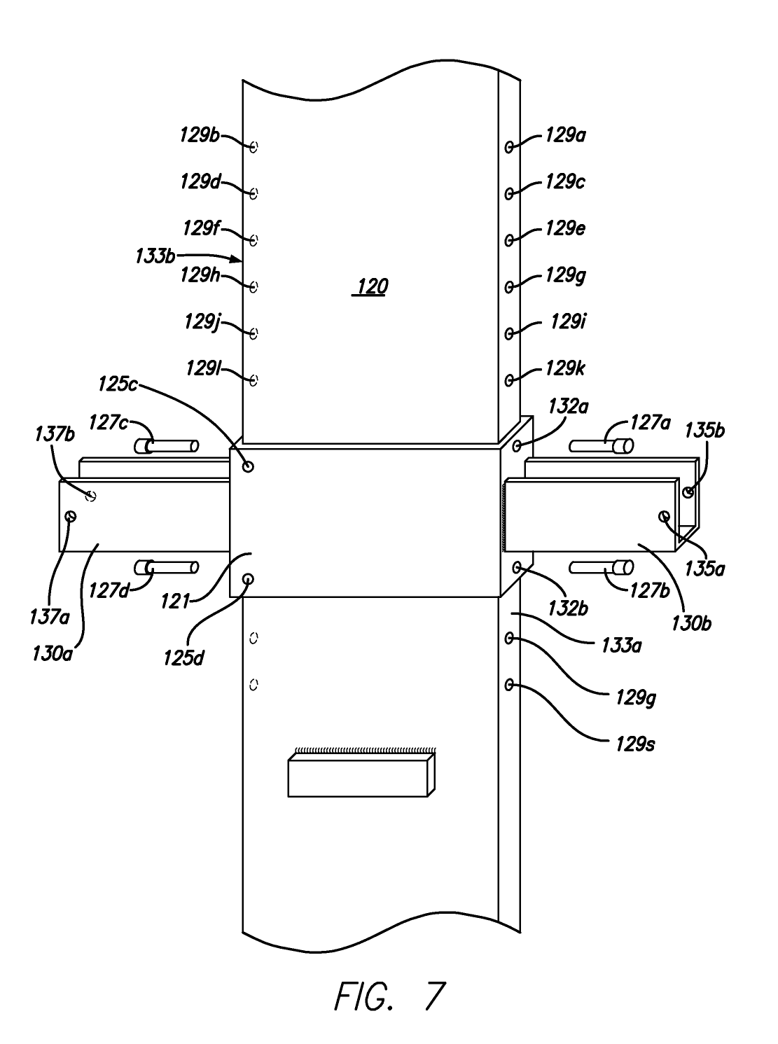

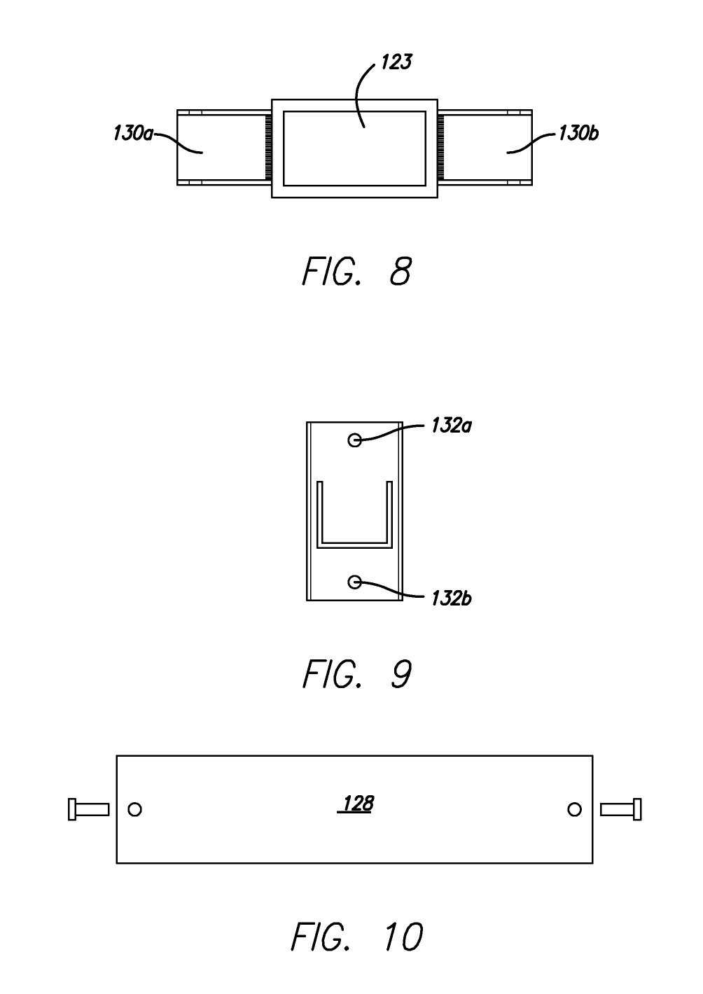

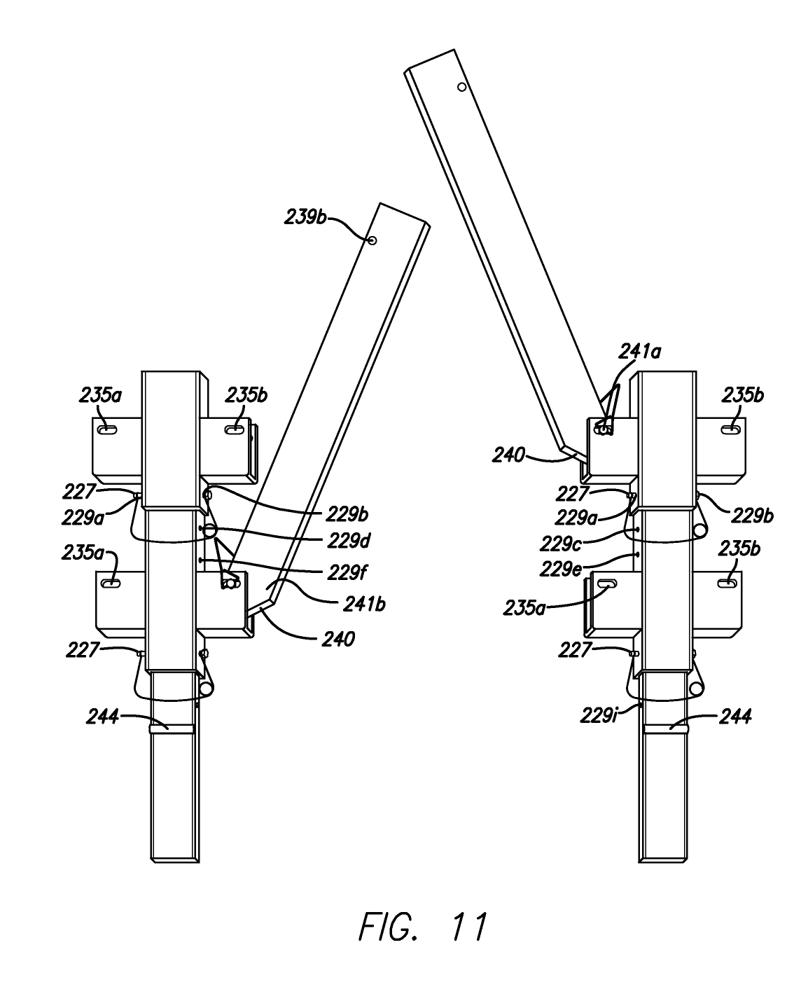

Turning now to FIG. 7, an alternate embodiment of the railing system of the applicant's invention is illustrated, which includes stake 120 and boot 121. Boot 121 further includes a pair of saddles 130a and 130b for receipt of an end of an arm 128 (see FIG. 10). Each end of the arms 128 are held in similar boots (not shown) on adjacent stakes (not shown) to from a rail. Again, as with the previous embodiment of the invention, the railing system can be continuous around the periphery of the truck bed, may cover a portion of the periphery, or may be discontinuous. The boot 121 has a central aperture 123, best seen in FIG. 8, which is dimensioned for telescopically mating with stake 120. Boot 121 includes boot holes 125a, 125b, 125c, 125d which are dimensioned to receive mounting bolts 127a, 127b, 127c, 127d, respectively so that the boot 121 can be detachably mounted to the stake 120 through any two sets of aligning stake holes 129ab, 129cd, 129ef, 129gh, 129ij, 129kl located on side walls 133a,b of boot 121 via insertion of boot bolts 132a and 132b. The saddles 130a and 130b may further include aligned apertures 135a, 135b and 137a, 137b which are dimension to receive cotter pins 141a, 141b to hold arms 128 to boot 120. The arms 128 have an aperture on each end 139a, 139b, which are dimensioned and positioned to receive the cotter pins 141a and 141b for securing the arm 128 to boots 121 located on adjacent stakes 120.

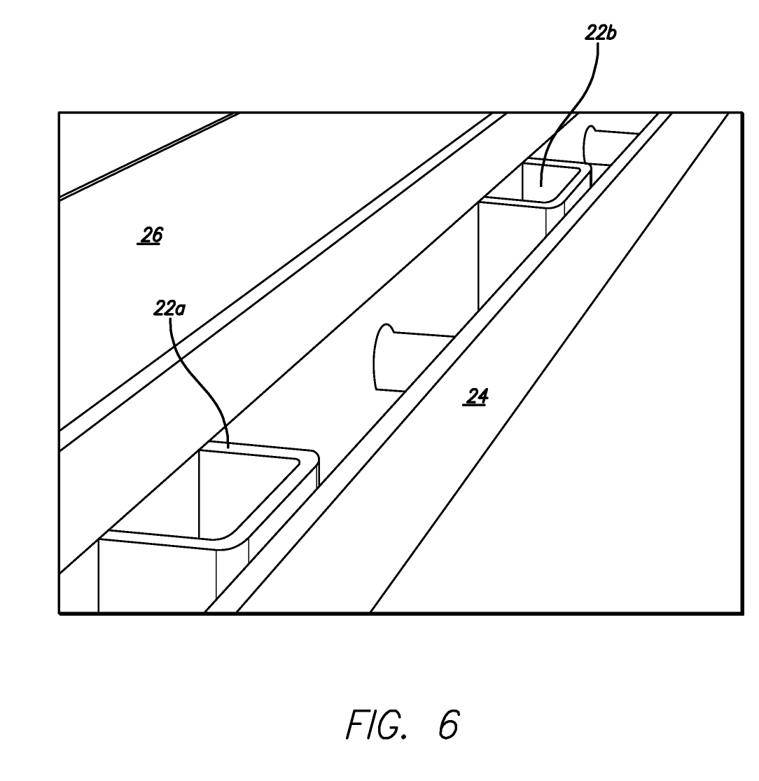

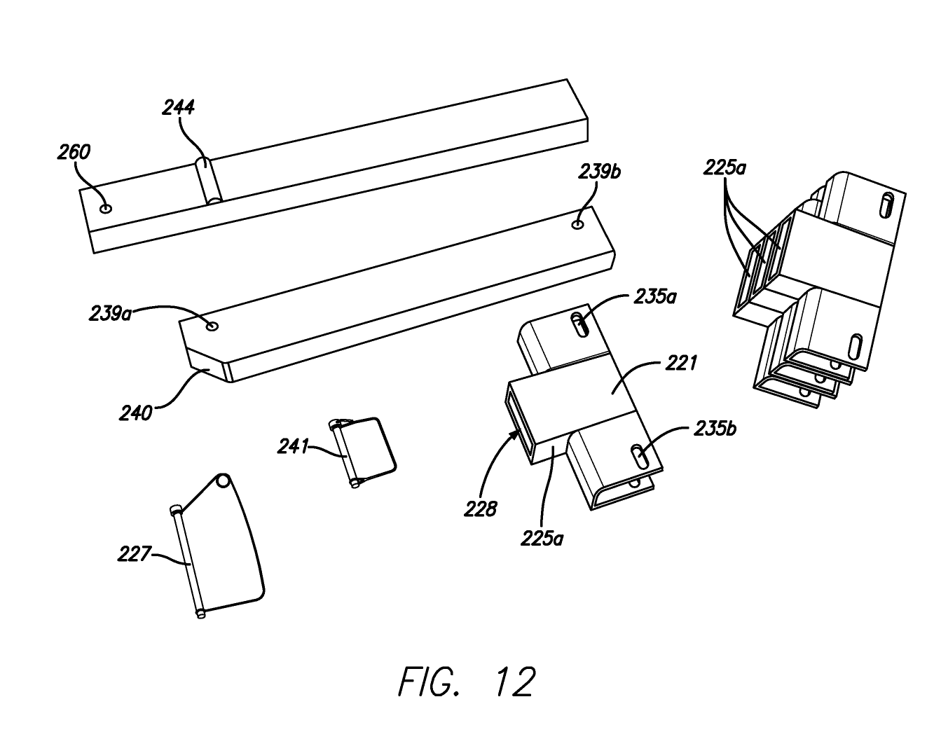

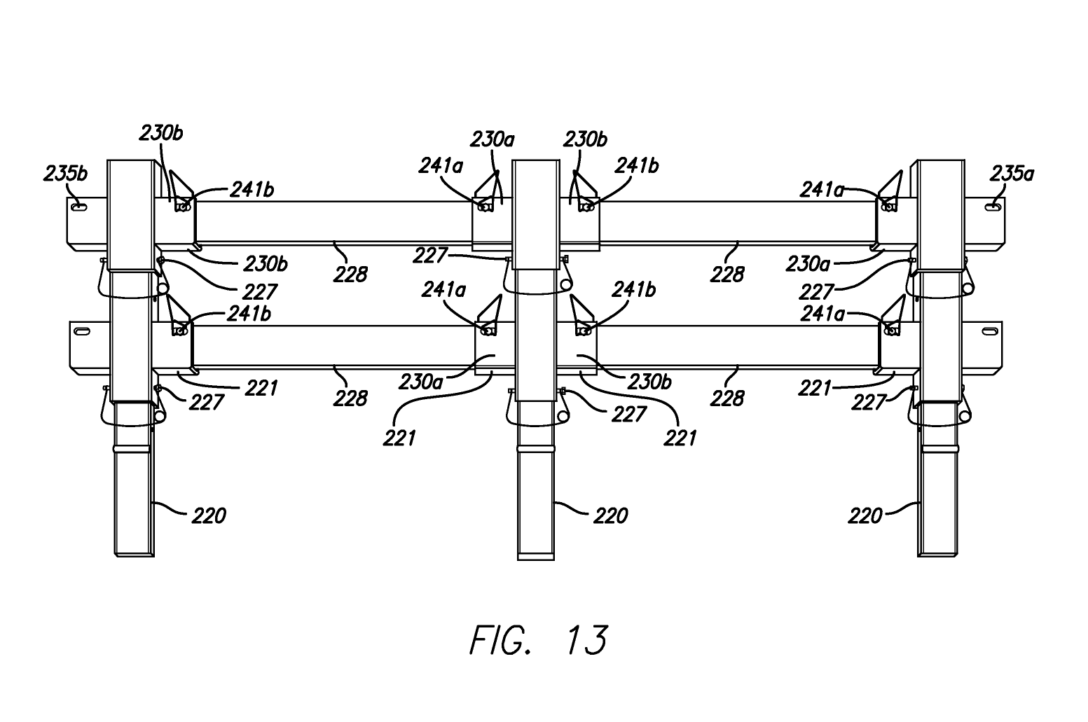

Turning to FIGS. 11-13, another alternate embodiment of the railing system of the applicant's invention is illustrated, which includes stakes 220 and boots 221. Each boot 221 further includes a pair of saddles 230a and 230b for receipt of an end of an arm 228 (see FIG. 11). Each end of the arms 228 are held in similar boots on adjacent stakes 221 to form a rail. As shown in FIGS. 11 and 13, the rail may include more than one set of arms 228 between the posts. Such a double (or even triple arm) configurations may be used where steel rolls of different heights are being simultaneously transported or where the driver or operator believes that additional strength may be needed to contain an especially heavy, or especially mobile load. Again as with the previous embodiments of the invention, the railing system can be continuous around the periphery of the truck bed, may cover a portion of the periphery, may be discontinuous, or may include diverse segments which are either single, double, or triple armed. The boots 221 each have a central aperture 223, best seen in FIG. 11, which is dimensioned for telescopically mating with stake 220. Boot 221 includes boot holes 225a and 225b which are dimensioned to receive mounting bolts 227 respectively so that the boot 221 can be detachably mounted to the stake 220 through any pair of aligned stake holes 229ab, 229cd, 229ef, 229gh, 229ij, located on side walls 233a,b of boots 221 via insertion of boot bolts 227a and 227b. The saddles 230a and 230b may further include aligned apertures 235a, 235b, which are dimension to receive cotter pins 214a, 214b to hold arms 228 to boots 220. The arms 228 have an aperture on each 239a, 239b, which are dimensioned and positioned to receive the cotter pins 241a and 241b for securing each end of arm 228 to boots 221 located on adjacent stakes 220. In the embodiment of FIGS. 11-13, the arms 228 are shown with only a single angled end 240. However, to allow pivoting from either end of the arms 228, it is contemplated that commercial versions of the rail systems of FIGS. 11-13 would include an angled end 240 on both ends of each of the arms 228. Furthermore, it is preferred that the stakes 220 also include a rub rail retention hole 260, which is dimensional to receive a cotter type pin (not shown) that will prevent the stake from bouncing upwardly out of a rub rail pocket when a truck encounters bumpy terrain that might dislodge one or more stakes of the rail system. The retention hole 260 is spaced apart from stops 244 along the bottom of the stakes 220 a distance that is slightly larger than the height of rub rail pockets 22 (see FIG. 6). The stakes 220 of the rail system of FIGS. 11-13 have a stop 244 for engaging the upper portion of the rub rail pocket 22 and the cotter pin inserted into the retention hold 260 for engaging the bottom portion of the rub rail pocket. This arrangement ensures that the railing system will not become unintentionally dislodged during transit.

What is claimed:

1. A detachable railing system for retaining a load on a flat bed truck having a plurality of pockets located about the periphery of the bed of the truck, the railing system comprising:
a plurality of detachable stakes have one end dimensioned for telescopic mating with one of the plurality of pockets, each of the plurality of stakes having a stake body and a saddle portion extending outwardly from the stake body; and
a plurality of arm members each of which has at least one end dimensioned for insertion into at least one of the saddles of the plurality of stakes and which is further dimensioned to span the length between adjacent stakes when the stakes are mounted a predetermined distance apart in adjacent pockets, each of the plurality of arms having a mounting portion dimensioned to detachably mount onto at least one saddle portion of at least one of the plurality of stakes.

2. The detachable railing system of claim 1 wherein at least one of the arm members are pivotally mounted to first and second adjacent saddles of first and second adjacent stakes by means of a hinging bolt passing through an aperture formed in a first end of the arm member and through an aperture formed in the first saddle on the first stake and by means of a locking pin passing through an aperture formed in the second end of the arm member and an aperture formed in a second saddle mounted on the second, adjacent stake.

3. The detachable railing system of claim 2 wherein the first end of the at least one of the arm member has a beveled lower surface to allow the lower surface of the first end of the at least one arm member to clear the first saddle of the first stake during pivoting of the arm member into an upright position for loading and unloading the flat bed truck.

4. The detachable railing system of claim 2 wherein the at least one arm member includes an arm pivot retaining tang located on the arm member above the first saddle of the first stake and dimensioned for retaining the at least one arm member in the upright position during the loading or unloading of the flat bed truck.

5. The detachable railing system of claim 2 wherein the at least one arm member includes an arm pivot retaining tang located on the arm member above the first saddle of the first stake and dimensioned for retaining the at least one arm member in the upright position during the loading or unloading of the flat bed truck.

6. The detachable railing system of claim 5 wherein the arm pivot retaining tang includes a pivoted arm retaining pin for receipt in an aperture dimensioned for receipt of same which is dimensioned and located to align with a pivot retaining aperture formed in the arm.

7. The detachable railing system of claim 1 wherein at least one of the stake members includes a spaced apart from the bottom surface of the stake a distance sufficient to allow insertion of the bottom portion of the stake in one of the pockets a sufficient distance to prevent the stake from being unintentionally dislodged during transport of a load.

8. The detachable railing system of claim 1 wherein a plurality of stakes are located in adjacent pockets arranged along at least one side of the flat bed truck, wherein each of a plurality of arms extends between and are mounted to a pair of adjacent stakes of the plurality of stakes, and wherein each of the plurality of arms includes a beveled lower surface to allow the lower surface of the first end of each of the plurality of arms to clear the saddle of the first stake of the pair of adjacent stakes in order to pivot at least one of the plurality of arm members into an upright position for side loading and side unloading a load from the flat bed truck via a forklift reaching between a adjacent pair of stakes with an upwardly pivoted arm.

9. The detachable railing system of claim 1 wherein the stakes and arms are made from steel of sufficient thickness and strength to retain a coil of sheet steel weighing not less than 600 pounds that has been caused to roll at a speed of about 5 miles per hour by dropping the coil from a height of not less than eighteen inches onto a flat bed truck.

10. A detachable railing system for retaining a load on a flat bed truck having a plurality of pockets located along the periphery of the flat bed, the railing system comprising:
a plurality of detachable stakes having one end dimensioned for telescopic mating with at least one of the plurality of pockets;
a plurality of boots being dimensioned to telescopically mate with at least one of the plurality of stakes for slidably mounting thereon;
each of the boots having at least one saddle portion extending outwardly and being dimensioned for receipt of one end of an arm member, and each boot also having multiple attachment sites extending along the vertical length of the stake for securing the boot at multiple points such that the railing system is adjustable to a plurality of different rail heights; and
a plurality of arm members being dimensioned for receipt of at least one of the saddles mounted to the plurality of stakes, the arms being further dimensioned to span the length between adjacent stakes when mounted a predetermined distance apart in the plurality of pockets.

11. A method of loading or unloading a load with a fork lift from a flat bed truck having a railing system including a plurality stakes mounted in pockets located about the periphery of the flat bed truck, the method including the steps of:
removing a securing member from at least one end of a pivotally mounted arm forming at least a portion of a railing around the periphery of a flat bed truck;
pivoting the arm upwardly into a substantially upright position to allow a forklift to access the load located on the flat bed truck from between adjacent stakes of the railing system; and
removing the load from the flat bed truck between the adjacent stakes with the upwardly pivoted arm with a forklift.

12. The method of claim 11 wherein a load is too large to be loaded on unloaded between adjacent stakes of the railing system and wherein the method includes the additional steps of removing at least which secures the stake to a portion of the remainder of the railing system, pulling at least one stake from the pocket of the flat bed truck, and removing the load from the flat bed truck in the gap in the railing created by pulling at least one stake from the pocket.

13. The method of claim 11 wherein the step of pivoting the arm upwardly further includes the step of selecting an arm joining a pair of adjacent stakes located along one of the sides of the flat bed truck for pivoting upwardly and the step of removing the load from the flat bed truck includes positioning the forklift along the side of the flat bed truck between the adjacent stakes with the upwardly pivoted arm and reaching the fork portion of the lift between the adjacent pair of stakes with the upwardly pivoted arm to lift the load and remove from the flat bed truck.
